(19) United States
(12) Patent Application Publication
(10) Pub. No.: US 2026/0111077 A1
(43) Pub. Date: Apr. 23, 2026

(54) ELECTRONIC DEVICE, ELECTRONIC SYSTEM AND OPERATING METHOD THEREOF

(71) Applicant: GIGAIPC CO., LTD., New Taipei City (TW)

(72) Inventor: Chih Sheng Chang, New Taipei City (TW)

(73) Assignee: GIGAIPC CO., LTD., New Taipei City (TW)

(21) Appl. No.: 19/361,008

(22) Filed: Oct. 17, 2025

(30) Foreign Application Priority Data
Oct. 18, 2024 (TW) 113139653

(51) Int. Cl. G06F 3/023; G06F 1/3215; G06F 1/3234

(52) U.S. Cl. CPC G06F 3/0232; G06F 1/3215; G06F 1/3271

(57) ABSTRACT

An electronic device, an electronic system, and an operating method thereof are provided. The electronic device includes a processor and a controller. The controller is coupled to the processor. The controller receives an input signal from an input device. The controller, based on a lookup table, performs a first control operation according to the input signal, alternatively, based on the lookup table, transfers the input signal to the processor, such that the processor performs a second control operation according to the input signal. Thereby, the electronic device is capable of increasing an efficiency of the control operation.

### CROSS-REFERENCE TO RELATED APPLICATION

This application claims the priority benefit of Taiwan application serial no. 113139653, filed on October 18, 2024. The entirety of the above-mentioned patent application is hereby incorporated by reference herein and made a part of this specification.

### BACKGROUND

### Technical Field

The disclosure relates to an electronic device, and particularly relates to an electronic device, an electronic system, and an operating method thereof that apply an input device to perform control operations.

### Related Art

Generally speaking, a user may operate a computer through an input device. The input device is, for example, a keyboard that applies Universal Serial Bus (hereinafter referred to as USB). When one or more keys of the keyboard are pressed, the keyboard generates corresponding input signals. The keyboard transfers the input signals to a processor of the computer through a USB interface, such that the processor performs corresponding control operations according to the input signals.

However, when the computer is busy, current input signals are limited by the bandwidth of the USB interface and cannot be efficiently transferred to the processor, thereby causing the processor to be unable to perform corresponding control operations in real time.

### SUMMARY

Embodiments of the disclosure provide an electronic device that can improve the efficiency of control operations corresponding to an input device.

The electronic device of the embodiment of the disclosure includes a processor and a controller. The controller is coupled to the processor. The controller is configured to receive an input signal from an input device. The controller is configured to perform a first control operation according to the input signals based on a lookup table, or transfer the input signals to the processor based on the lookup table, such that the processor performs a second control operation according to the input signal.

Embodiments of the disclosure further provide an electronic system. The electronic system includes an input device and an electronic device. The input device is configured to generate input signals. The electronic device is coupled to the input device. The electronic device includes a processor and a controller. The controller is coupled to the processor and the input device. The controller is configured to receive the input signals. The controller is configured to perform a first control operation according to the input signals based on a lookup table, or transfer the input signals to the processor based on the lookup table, such that the processor performs a second control operation according to the input signals.

Embodiments of the disclosure further provide an operating method of an electronic system. The operating method includes the following steps. An input signal is generated through an input device, and the input signal is transferred to a controller. A first control operation is performed according to the input signal through the controller based on a lookup table, or the input signal is transferred to a processor through the controller based on the lookup table, such that the processor performs a second control operation according to the input signal.

Based on the above, the electronic device, the electronic system, and the operating method thereof of the embodiments of the disclosure apply an input device to obtain input signals, and determine whether to directly perform control operations corresponding to the input signals through a controller based on a lookup table, which can perform corresponding control operations in real time without being affected by the bandwidth of the transmission interface.

To make the foregoing features and advantages of the disclosure more comprehensible, embodiments are specifically provided below and described in detail in conjunction with the accompanying drawings as follows.

### BRIEF DESCRIPTION OF THE DRAWINGS

FIG. 1 is a block diagram of an electronic system according to an embodiment of the disclosure.

FIG. 2 is a flowchart of an operating method of an electronic system according to an embodiment of the disclosure.

FIG. 3 is an operation schematic diagram of an electronic device according to an embodiment of the disclosure.

FIG. 4 is an operational flowchart of the electronic device according to the embodiment of FIG. 3 of the disclosure.

FIG. 5 is an operational flowchart of the electronic device according to the embodiment of FIG. 3 of the disclosure.

FIG. 6 is an operation schematic diagram of an electronic system according to an embodiment of the disclosure.

### DESCRIPTION OF THE EMBODIMENTS

Some embodiments of the disclosure will be described in detail with reference to the accompanying drawings. Regarding the reference numerals mentioned in the following description, when the same reference numerals appear in different drawings, the numerals will be regarded as the same or similar elements. The embodiments are merely a part of the disclosure and do not disclose all possible implementations of the disclosure. More specifically, the embodiments are merely examples within the scope of the claims of the disclosure.

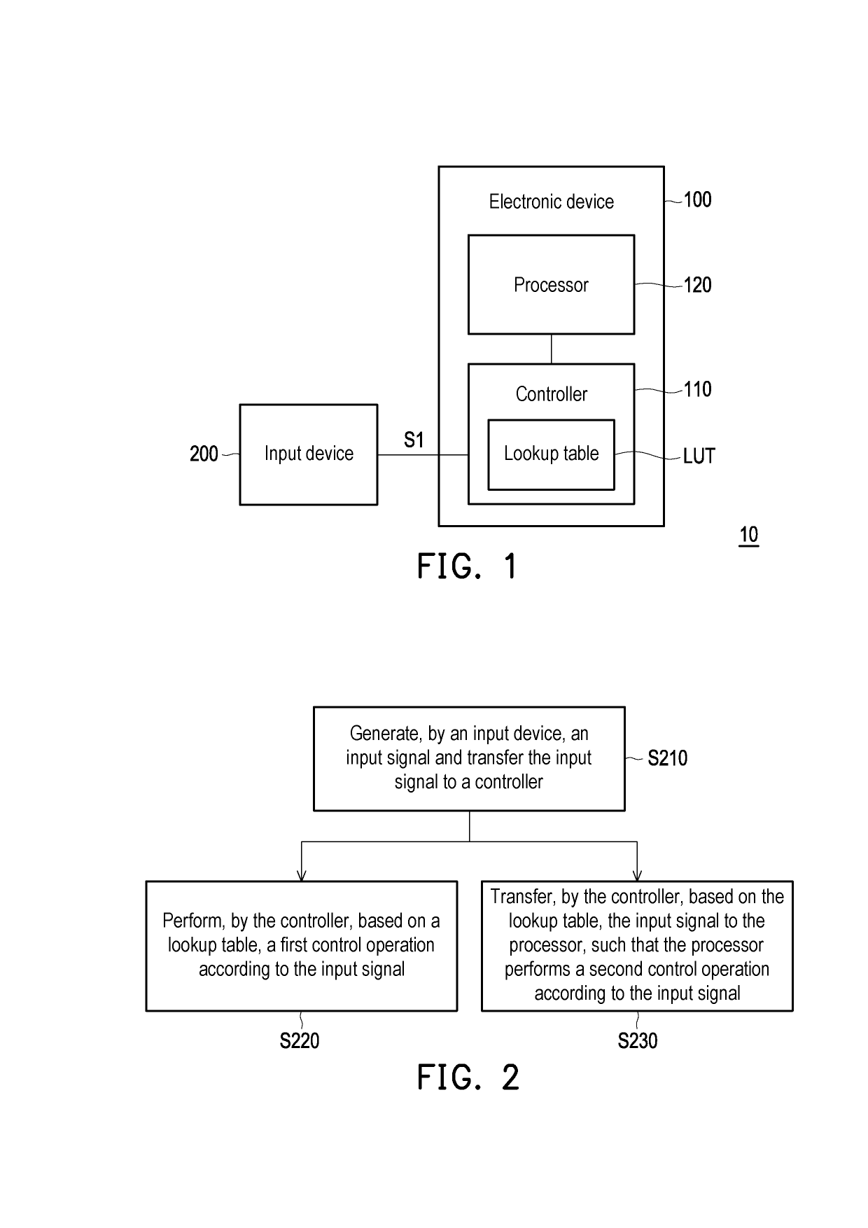

FIG. 1 is a block diagram of an electronic system according to an embodiment of the disclosure. Referring to FIG. 1, an electronic system 10 includes an electronic device 100 and an input device 200. The electronic device 100 is coupled to the input device 200. A user may perform a control operation on the electronic device 100 through the input device 200, such that the electronic device 100 implements corresponding functions.

In the embodiment, the input device 200 may be externally connected to the electronic device 100 through an input connection port (not shown) in the electronic device 100. The input device 200 is a human interface device (HID) that applies USB transmission specification. The input device 200 is, for example, a keyboard, or an electronic device having multiple keys to implement keyboard function. In some embodiments, the input device 200 may be connected to the electronic device 100 through wireless transmission.

In the embodiment, the electronic device 100 is, for example, a mobile phone, a computer device, a tablet computer, a notebook computer, a desktop computer, or other electronic devices. The electronic device 100 includes a controller 110 and a processor 120. The controller 110 is coupled to the processor 120 and the input device 200.

In the embodiment, the controller 110 is, for example, an embedded controller (EC), a power delivery (PD) controller, or other similar devices or a combination of these devices, which may load and execute computer program related firmware or software to implement control and execution functions.

In the embodiment, the processor 120 is, for example, a micro controller unit (MCU), a signal converter, a field programmable gate array (FPGA), a central processing unit (CPU), or other programmable general-purpose or special-purpose microprocessor, a digital signal processor (DSP), a programmable controller, an application specific integrated circuit (ASIC), a programmable logic device (PLD), or other similar devices or a combination of these devices, which may load and execute related firmware or software to implement control and execution functions.

FIG. 2 is a flowchart of an operating method of an electronic system according to an embodiment of the disclosure. Referring to FIGS. 1 and 2, the electronic system 10 executes Steps S210 to S230. The sequence of Steps S210 to S230 is merely for exemplary description, and the disclosure is not limited thereto.

In Step S210, in response to an operation from a user on the input device 200 (for example, pressing a key of the input device 200), the input device 200 generates an input signal S1 and transfers the input signal S1 to the controller 110. The input signal S1 indicates a control command of the user operating the input device 200.

Next, the controller 110 receives the input signal S1. In addition, the controller 110 accesses a lookup table LUT. The lookup table LUT indicates a correspondence relationship between control commands and control operations corresponding to the input device 200. The lookup table LUT is, for example, stored in the controller 110, or stored in a memory (not shown) of the electronic device 100.

In the embodiment, based on the lookup table LUT and the input signal S1, the controller 110 determines whether to process the input signal S1 by itself or provide to the processor 120 to process the input signal S1. That is, the controller 110 selectively executes Step S220 or Step S230 according to the lookup table LUT and the input signal S1.

In Step S220, the controller 110 performs a first control operation according to the input signal S1 based on the lookup table LUT. The first control operation is a control operation indicated in the lookup table LUT. The first control operation is, for example, controlling a current operation mode of the electronic device 100, or controlling the electronic device 100 to implement various functions applied thereto.

Alternatively, in Step S230, the controller 110 transfers the input signal S1 to the processor 120 based on the lookup table LUT, such that the processor 120 performs a second control operation according to the input signal S1. The second control operation is, for example, controlling a current operation mode of the electronic device 100, or controlling the electronic device 100 to implement various functions applied thereto, and is different from the first control operation.

It is worth mentioning that through the controller 110 selectively processing the input signal S1 by itself based on the lookup table LUT according to the input signal S1, the electronic device 100 can directly perform the control operation corresponding to the input signal S1. Thus, the electronic device 100 can avoid transferring the input signal S1 to other control components (for example, the processor 120) without being affected by the bandwidth of the transmission interface, so as to respond to the input signal S1 to perform the corresponding control operation in real time.

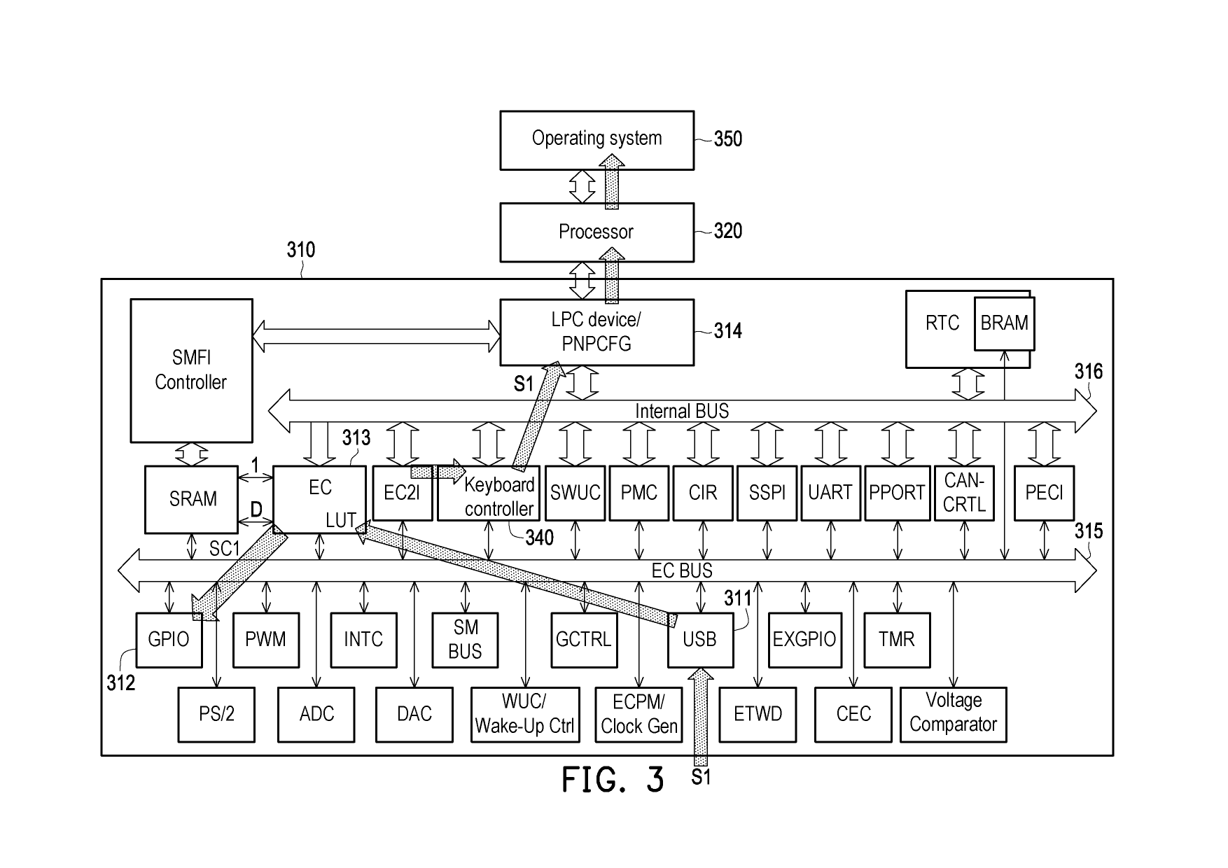

FIG. 3 is a schematic diagram of operation of an electronic device according to an embodiment of the disclosure. Referring to FIG. 3, an electronic device 300 applies a USB transmission specification. The electronic device 300 includes a controller 310 and a processor 320. The electronic device 300 may be applied in the electronic system 10 in FIG. 1. The electronic device 300 is further coupled to an input device (for example, the input device 200 shown in FIG. 1) to use the input device. Regarding the controller 310, the processor 320, and the input device, reference may be made to the related description of the electronic device 100 and be analogized accordingly.

In the embodiment of FIG. 3, the controller 310 applies a USB HID protocol to receive the input signal S1 from the input device. The controller 310 is, for example, an embedded controller (EC), and is, for example, implemented with an integrated circuit.

In the embodiment, the controller 310 includes a plurality of blocks and a plurality of buses to exemplify the internal functions of the embedded controller. For example, the plurality of blocks include such as a USB interface 311, a General-purpose input/output (GPIO) interface 312, a host interface 313, and an LPC (Low pin count) and PNPCFG logic device interface 314. The plurality of buses include an EC bus interface 315 and an internal bus interface 316.

In the embodiment, the electronic device 300 further includes a keyboard controller (KBC) 340. The keyboard controller 340 is coupled to the controller 310 and the processor 320. The keyboard controller 340 is, for example, implemented with an integrated circuit. The keyboard controller 340 is, for example, integrated in the controller 310.

In the embodiment, the electronic device 300 further includes an operating system (OS) 350. The operating system 350 is coupled to the controller 310 through the processor 320.

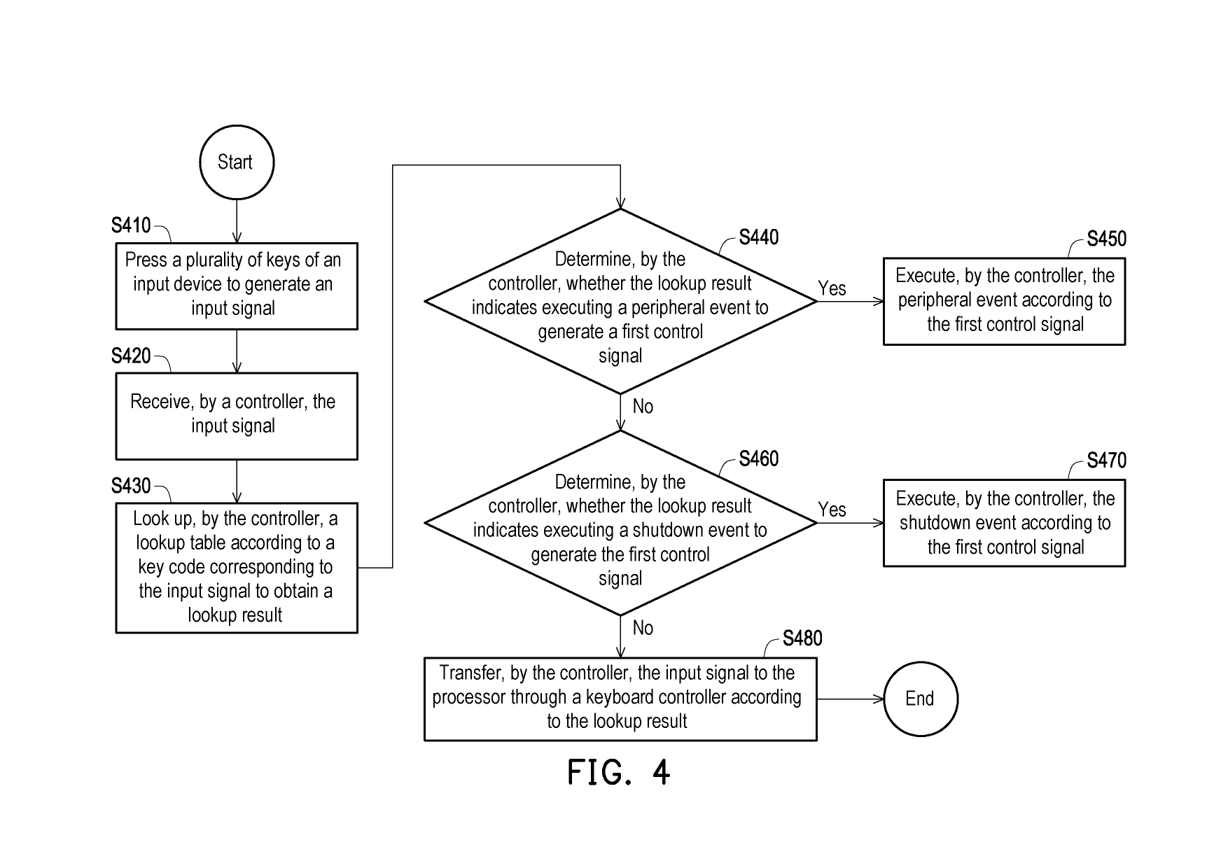

FIG. 4 is an operation flowchart of the electronic device according to the embodiment of FIG. 3 of the disclosure. Referring to FIGS. 3 and 4, the electronic device 300 executes Steps S410 to S480. The Steps S410 to S480 are applied in a work mode of the electronic device 300. The sequence of Steps S410 to S480 is merely for exemplary description, and the disclosure is not limited thereto.

In Step S410, a plurality of keys of the input device are pressed to generate the input signal S1. In the embodiment, the input signal S1 corresponds to a key code formed by the plurality of keys to indicate a target control instruction.

In the embodiment, a plurality of keys of the input device are pressed simultaneously. The pressed keys include a modifier key and at least one non-modifier key. The modifier key is, for example, "Shift", "Ctrl", "Alt", "Win" (that is, Windows logo), or a key configured to combine with other keys to indicate a specific function. The non-modifier key is, for example, various letter keys or number keys. The non-modifier key may also be referred to as a generic key.

In Step S420, the controller 310 receives the input signal S1. In detail, the controller 310 receives and transfers the input signal S1 from the input device through the USB interface 311 and the EC bus interface 315, and receives the input signal S1 through the host interface 313. In addition, the controller 310 accesses the lookup table LUT through the host interface 313.

In Step S430, the controller 310 looks up the lookup table LUT according to the key code corresponding to the input signal S1 through the host interface 313 to obtain a lookup result. The lookup result indicates the control operation corresponding to the aforementioned key code.

In the embodiment, the lookup table LUT includes a correspondence relationship between key codes and control operations. The key codes in the lookup table LUT include key codes corresponding to a combination of a single modifier key and a plurality of non-modifier keys. That is, the lookup table LUT indicates a correspondence relationship between key combinations of the modifier key and the plurality of non-modifier keys and control operations.

It should be noted that, since the hotkeys preset by the operating system 350 are limited by the bandwidth of transmission interfaces (including the interfaces 315 and 316 that apply USB transmission specification), the preset hotkeys are formed by a single modifier key and a single non-modifier key. Different from the key combinations of the preset hotkeys, the key combinations in the lookup table LUT are formed by a single modifier key and a plurality of non-modifier keys (for example, 2, or even 6). Thus, the key combinations in the lookup table LUT do not conflict with the hotkeys preset by the operating system 350, and may indicate respective shortcut functions.

For example, the key combination in the lookup table LUT includes the modifier key "Alt", the non-modifier key "G", and the non-modifier key "P". This key combination indicates control of the media device connected to the GPIO interface 312. As another example, the key combination in the lookup table LUT includes the modifier key "Alt", the non-modifier key "P", and the non-modifier key "R". This key combination indicates control of the power module of the electronic device 300 (for example, a "HW RESET SYSTEM" module) to switch the current operation mode of the electronic device 300.

In some embodiments, the key codes in the lookup table LUT include key codes corresponding to a combination of a single modifier key and a single non-modifier key. The aforementioned key combinations are different from the hotkeys preset by the operating system 350.

Next, the electronic device 300 executes Steps S440 to S480 to continue the control operation in the work mode. Specifically, the controller 310 generates a first control signal SC1 according to the lookup result in Step S430 through the host interface 313 to perform a first control operation according to the first control signal SC1, or transfers the input signal S1 to the processor 320 through the keyboard controller 340.

That is, when the key code corresponding to the input signal S1 matches the key code in the lookup table LUT, it is indicated that the lookup result shows that the control operation corresponding to the key code may be processed by the controller 310 itself. The electronic device 300 continues to Steps S440 to S470.

In Step S440, when the electronic device 300 operates in the work mode, the controller 310 determines whether the lookup result indicates executing a first control operation (for example, a peripheral event) to generate a first control signal SC1.

Next, in Step S450, according to the result of determining yes in Step S440, the controller 310 executes a peripheral event according to the first control signal SC1 to control the media device used by the electronic device 300.

Specifically, the controller 310 transfers the first control signal SC1 to the GPIO interface 312 through the host interface 313, so as to output the first control signal SC1 to the controlled media device through the GPIO interface 312. The media device operates according to the first control signal SC1 to implement the corresponding function.

In this embodiment, the peripheral event is, for example, a control operation configured to control the media device used by the electronic device 300, thereby implementing various functions applied by the electronic device 300. The peripheral event includes, for example, control operations such as controlling the brightness of the display of the electronic device 300 and adjusting the volume of the electronic device 300.

In Step S460, according to the result of determining no in Step S440, the controller 310 further determines whether the lookup result indicates executing another first control operation (for example, a shutdown event) to generate the first control signal SC1. In some embodiments, the controller 310 first determines whether the lookup result indicates executing a shutdown event, and after obtaining a result of determining no, continues to determine whether the lookup result indicates executing a peripheral event.

Next, in Step S470, according to the result of determining yes in Step S460, the controller 310 executes a shutdown event according to the first control signal SC1 to cause the electronic device 300 to enter a non-work mode.

Specifically, the controller 310 outputs the first control signal SC1 to the power module of the electronic device 300 through the host interface 313. The power module operates according to the first control signal SC1 to be switched from the work mode to the non-work mode.

In this embodiment, the shutdown event is, for example, a control operation that switches the electronic device 300 from the work mode to shutdown. In some embodiments, the shutdown event in Steps S460 to S470 may be replaced by a sleep event to switch the electronic device 300 from the work mode to the sleep mode.

On the other hand, when the key code corresponding to the input signal S1 does not match the key code in the lookup table LUT, it is indicated that the lookup result shows that the control operation corresponding to the key code cannot be processed by the controller 310 itself, but is processed by other control elements (for example, the processor 320). The electronic device 300 continues to Step S480.

In Step S480, the controller 310 transfers the input signal S1 to the processor 320 through the keyboard controller 340 according to the lookup result. In detail, according to the results of determining no in both Steps S440 and S460, the keyboard controller 340 receives the input signal S1 transferred from the host interface 313 of the controller 310. The keyboard controller 340 transfers the input signal S1 to the processor 320 through the internal bus interface 316 and the LPC and PNPCFG logic device interface 314.

Following the above description, when the processor 320 receives the input signal S1 transferred by the controller 310, the processor 320 performs a second control operation according to the key code corresponding to the input signal S1. In this embodiment, the processor 320 transfers the input signal S1 to the operating system 350, such that the operating system 350 performs the second control operation according to the input signal S1.

It should be noted that the key code corresponding to the input signal S1 in Step S480 is different from the key code in the lookup table LUT. The key code corresponding to this input signal S1 is, for example, the key code of the hotkey preset by the operating system 350. That is, the second control operation is, for example, the control operation corresponding to the preset hotkey.

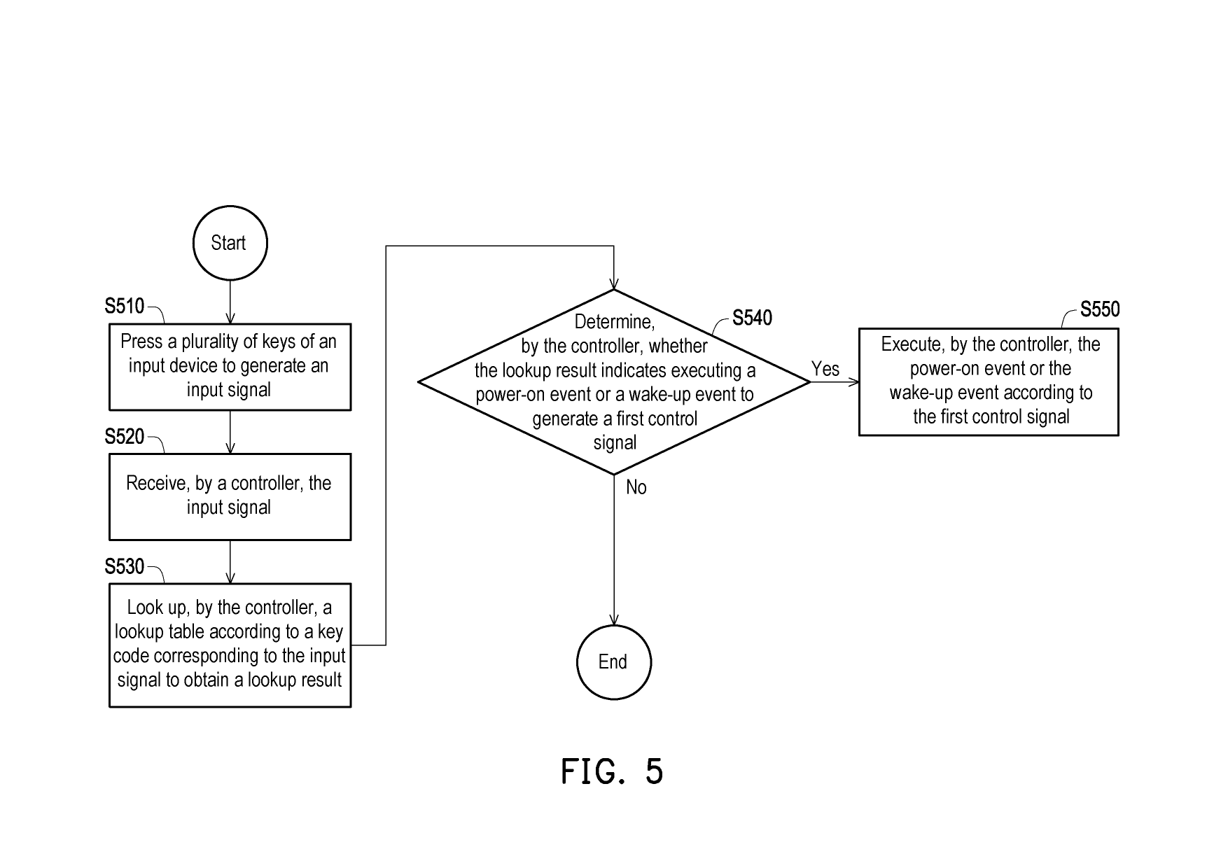

FIG. 5 is an operation flowchart of the electronic device according to the embodiment of FIG. 3 of the disclosure. Referring to FIGS. 3 and 5, the electronic device 300 executes steps S510 to S550. The Steps S510 to S550 may be applied in the non-work mode of the electronic device 300. The sequence of Steps S510 to S550 is merely for exemplary description, and the disclosure is not limited thereto. The non-work mode is, for example, a shutdown mode or a sleep mode.

In Step S510, multiple keys of the input device are pressed to generate the input signal S1. In Step S520, the controller 310 receives the input signal S1. In Step S530, the controller 310 looks up the lookup table LUT according to the key code corresponding to the input signal S1 to obtain a lookup result. Regarding the Steps S510 to S530, reference may be made to the related descriptions of Steps S410 to S430 and be analogized accordingly.

In this embodiment, according to the lookup result in Step S530, the electronic device 300 executes Steps S540 to S550 to continue the control operation in the non-work mode. When the key code corresponding to the input signal S1 matches the key code in the lookup table LUT, it is indicated that the lookup result shows that the control operation corresponding to the key code may be processed by the controller 310 itself.

In Step S540, when the electronic device 300 operates in the non-work mode, the controller 310 determines whether the lookup result indicates executing a first control operation (for example, a power-on event or a wake-up event) to generate a first control signal SC1.

Next, in Step S550, according to the result of determining yes in Step S540, the controller 310 executes a power-on event to power on the electronic device 300, or executes a wake-up event to wake up the electronic device 300 according to the first control signal SC1.

On the other hand, according to the result of determining no in Step S540, the controller 310 determines that the lookup result does not indicate executing a power-on event or a wake-up event, such that the electronic device 300 maintains in the non-work mode.

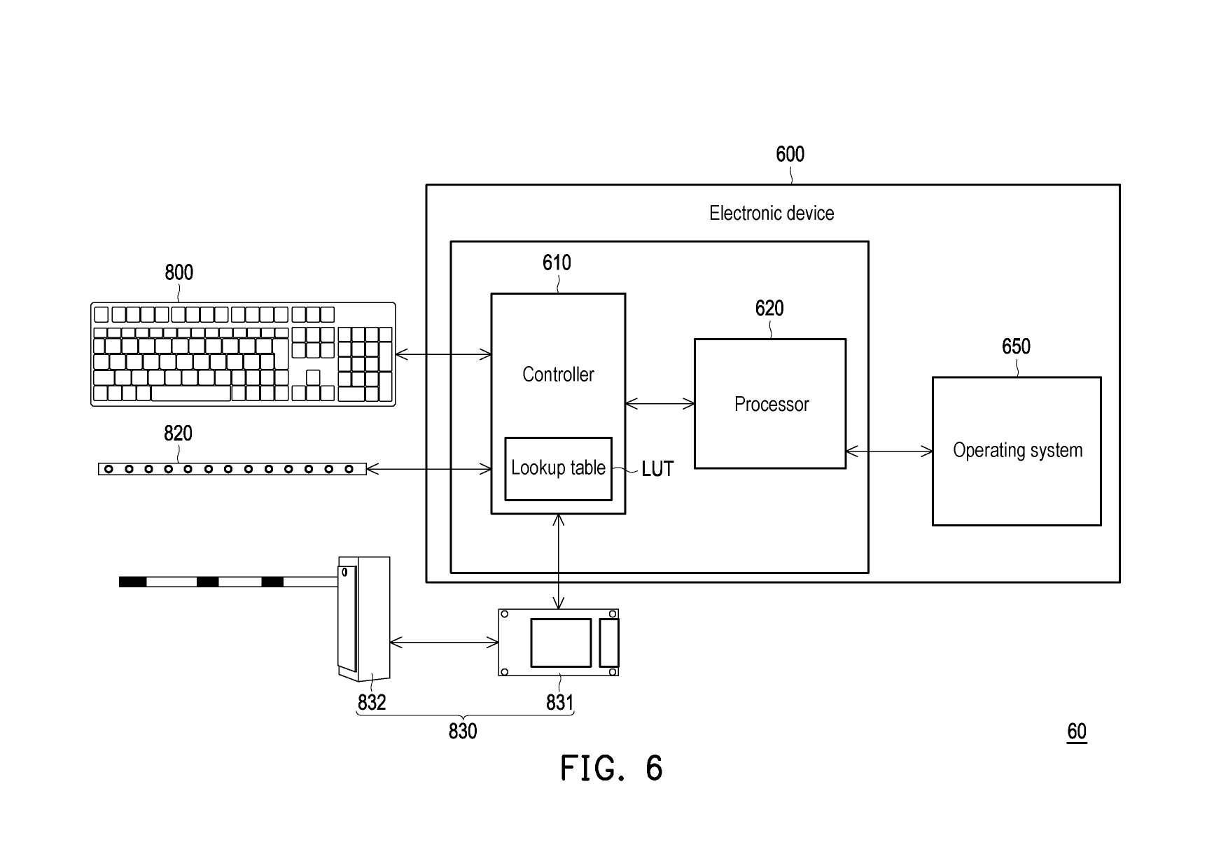

FIG. 6 is an operation schematic diagram of an electronic system according to an embodiment of the disclosure. Referring to FIG. 6, an electronic system 60 includes an electronic device 600 and an input device 800. The electronic device 600 includes a controller 610, a processor 620, and an operating system 650. Regarding the controller 610, the processor 620, the operating system 650, and the input device 800, reference may be made to the related descriptions of the electronic device 300 and be analogized accordingly.

In the embodiment of FIG. 6, the media devices used by the electronic device 600 include an external lighting device 820 and a wirelessly connected barrier device 830. The barrier device 830 includes a relay 831 and a barrier 832. The media devices and the quantities thereof shown in FIG. 6 are merely exemplary descriptions.

In this embodiment, the user controls the lighting effect of the lighting device 820 through pressing a single modifier key and multiple non-modifier keys of the input device 800. Alternatively, the user controls whether the relay 831 is conductive through pressing a single modifier key and multiple non-modifier keys of the input device 800, so as to further control the opening or closing of the barrier 832.

In summary, the electronic device, the electronic system, and the operating method thereof according to embodiments of the disclosure enable the controller to select whether to process the input signal by itself or transfer the input signal to the processor through the keyboard controller based on a lookup table according to input signals corresponding to multiple keys, and are capable of executing specific control operations without being affected by the bandwidth of the transmission interface. In some embodiments, based on key combinations specified by the lookup table, the controller is capable of avoiding accidental activation of hotkeys preset by the operating system. In addition, the controller is also capable of powering on, shutting down, or waking up the electronic device in various operation modes.

Although the disclosure has been disclosed above with the embodiments, the embodiments are not used to limit the disclosure. Persons having ordinary knowledge in the technical field may make slight changes and modifications without departing from the spirit and scope of the disclosure. Therefore, the protection scope of the disclosure shall be defined by the appended claims.

What is claimed is:

1. An electronic device, comprising:
a processor; and
a controller coupled to the processor, and configured to:
receive an input signal from an input device; and
perform a first control operation based on a lookup table according to the input signal; or
transfer the input signal to the processor based on the lookup table such that the processor performs a second control operation according to the input signal.

2. The electronic device as claimed in claim 1, wherein the controller is configured to:
look up the lookup table according to a key code corresponding to the input signal to obtain a lookup result;
generate a first control signal according to the lookup result to perform the first control operation according to the first control signal, or transfer the input signal to the processor through a keyboard controller.

3. The electronic device as claimed in claim 2, wherein in response to the electronic device operating in a work mode, the controller is configured to control a media device used by the electronic device according to the first control signal.

4. The electronic device as claimed in claim 2, wherein in response to the electronic device operating in a work mode, the controller is configured to cause the electronic device to enter a non-work mode according to the first control signal.

5. The electronic device as claimed in claim 2, wherein in response to the electronic device operating in a non-work mode, the controller is configured to power on or wake up the electronic device according to the first control signal.

6. The electronic device as claimed in claim 1, wherein the input signal corresponds to a key code formed by a plurality of keys, wherein the lookup table comprises a correspondence relationship between key codes and control operations, and the key codes in the lookup table comprise key codes corresponding to a combination of a modifier key and a plurality of non-modifier keys.

7. The electronic device as claimed in claim 1, wherein the processor is configured to:
in response to receiving the input signal transferred by the controller, perform the second control operation according to a key code corresponding to the input signal, wherein the key code corresponding to the input signal is different from the key codes in the lookup table.

8. The electronic device as claimed in claim 1, further comprising:
a keyboard controller coupled to the processor and the controller, configured to receive the input signal transferred from the controller, and transferring the input signal to the processor.

9. An electronic system, comprising:
an input device configured to generate an input signal; and
an electronic device coupled to the input device, and comprising a processor and a controller, wherein the controller is coupled to the processor and the input device, and the controller is configured to:
receive the input signal; and
perform a first control operation based on a lookup table according to the input signal; or
transfer the input signal to the processor based on the lookup table such that the processor performs a second control operation according to the input signal.

10. An operating method of an electronic system, comprising:
through an input device, generating an input signal and transferring the input signal to a controller; and
through the controller, based on a lookup table, performing a first control operation according to the input signal; or
through the controller, based on the lookup table, transferring the input signal to a processor, such that the processor performs a second control operation according to the input signal.
